(19) United States
(12) Patent Application Publication
(10) Pub. No.: US 2013/0098471 A1
(43) Pub. Date: Apr. 25, 2013

(54) Aircraft nacelle comprising a hot air supply device for a panel combining acoustic and frost treatments

(71) Applicants: ALAIN PORTE, Colomiers (FR); FRÉDÉRIC CHELIN, Encausse (FR); PASCAL GALLETTI, Toulouse (FR)

(72) Inventors: ALAIN PORTE, Colomiers (FR); FRÉDÉRIC CHELIN, Encausse (FR); PASCAL GALLETTI, Toulouse (FR)

(73) Assignee: AIRBUS OPERATIONS SAS, Toulouse (FR)

(21) Appl. No.: 13/632,820

(22) Filed: Oct. 1, 2012

(30) Foreign Application Priority Data
Oct. 3, 2011 (FR) 11 58895

(51) Int. Cl. F02C 7/04

(52) U.S. Cl. CPC F02C 7/04
USPC 137/15.1

(57) ABSTRACT

The object of the invention is an aircraft nacelle comprising a lip extended by an inner conduit forming an air intake, a front frame delimiting with said lip annular channel within which hot air circulates, and a panel for acoustic treatment comprising, from outside inwardly, an acoustic resistive layer, at least one honeycomb structure and one reflective layer as well as ducts for channeling hot air, at least one conduit with opening which opens into annular channel being provided for carrying hot air up to the panel for acoustic treatment, wherein opening is used for channeling hot air in direction which forms an angle β of less than 60° with hot air flow direction into annular channel.

The present invention relates to an aircraft nacelle comprising means for supplying hot air to a panel combining both acoustic treatment and frost treatment.

An aircraft propulsion unit comprises a nacelle in which a traction system is arranged in a substantially concentric fashion.

As shown in FIG. 1, nacelle 10 includes in the front air intake 12 for channeling airflow in the direction of the traction system.

Following a longitudinal section (containing the traction system rotation axis), air intake 12 includes lip 14 extending outside the nacelle through outer wall 16 and inside through inner wall 18 defining inner conduit 20 for channeling air in the direction of the traction system.

Said nacelle also includes front frame 22 which defines, with lip 14, annular channel 24 which may be used to channel hot air for frost treatment.

In order to limit noise impact, techniques have been developed to reduce internal noise, notably by providing, on the walls of inner conduit 20, panels or coatings to absorb some of the acoustic energy, namely using Helmholtz resonator principle.

In order to optimize acoustic treatment, such panels should cover the largest area. Some of panels 26 for acoustic treatment may cover inner conduit 20, those panels distant from the front frame have no frost treatment function. Others may be arranged inside annular channel 24 at the front of frame 22 and may combine both acoustic and frost treatment functions. Finally, a panel 28 for acoustic treatment with heat resistant materials may be interposed between front frame 22 and panels 26. This panel 28 is also capable of frost treatment and includes means for capturing hot air into annular channel 24 and discharging it rearwardly into inner conduit 20.

Such a panel combining both acoustic and frost treatment functions has been described in patent FR 2,917,067. It comprises, from outside inwardly, an acoustic resistive layer, at least one honeycomb structure and a reflective layer, as well as ducts each defined by a wall interposed between the acoustic resistive layer and the honeycomb structure.

This solution may reduce the risk of communication between the interior of the ducts and the honeycomb structure cells, and thus the risk of disturbing acoustic treatment.

According to another advantage, hot air has a volume significantly less compared to prior solutions whereby it occupies the volume of some honeycomb structure cells, which provides, on the one hand, a better hot air concentration against the wall to be defrosted, increasing defrosting efficiency, and, on the other hand, a higher air pressure limiting the risk of a pressure within the structure less than the external pressure, and thus of external air penetrating inside the defrost system.

According to another advantage, hot air is in constant contact with the skin to be defrosted, which can improve exchange and reduce the temperature of hot air pushed rearwardly through the defrost system outlet, which would reject it without risking to burn the wall crossed, especially when the latter is made of a heat sensitive material such as a composite.

In general, each duct intended to channel hot air communicates through a first end with the annular channel and opens via an opening into inner conduit 20. These ducts extend in the longitudinal direction and are distributed over the entire circumference of inner conduit 20.

At the level of annular channel 24, hot air is generally injected at a point of the circumference and flows into the annular channel revolving several times. Means are provided to homogenize the air temperature inside of the annular channel. In order to ensure hot air transfer from the annular channel to the ducts, it is necessary to provide a separator with ducts to drive hot air from the annular channel to the ducts of the acoustic panel. Like acoustic treatment ducts, the separator ducts are longitudinally oriented, i.e. perpendicular to the hot air stream circulating within the annular channel. This arrangement does not enable to optimize the hot air flow from the annular channel to the acoustic panel ducts.

Thus, this invention aims to overcome the drawbacks of prior art by providing a nacelle equipped with a hot air feeding device for a panel combining both acoustic and frost treatment functions that optimizes hot air flow in the direction of said panel.

To this end, the invention relates to an aircraft nacelle comprising a lip extended by an inner conduit forming an air intake, a front frame delimiting, with said lip, an annular channel through which hot air circulates, as well as a panel for acoustic treatment comprising, from outside inwardly, an acoustic resistive layer, at least one honeycomb structure, and a reflective layer, as well as ducts for driving hot air, at least one conduit with one opening that opens into said annular channel, provided for carrying hot air up to the panel for acoustic treatment, wherein said opening helps channel hot air in a direction which forms an angle β of less than 60° with the direction of the hot air flow in said annular channel.

Other features and advantages will become apparent from the following description of the invention, description provided as an example only, with reference to the accompanying drawings in which:

FIG. 1 is a longitudinal section of a portion of an air intake according to prior art,

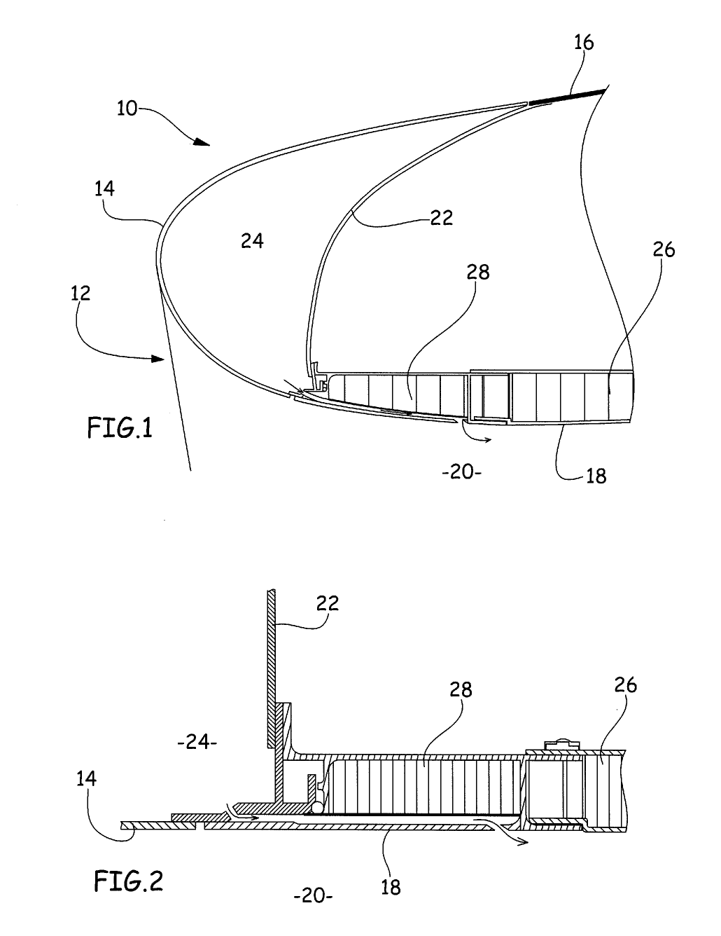

FIG. 2 is a cross-section view illustrating in detail a panel for acoustic treatment according to prior art,

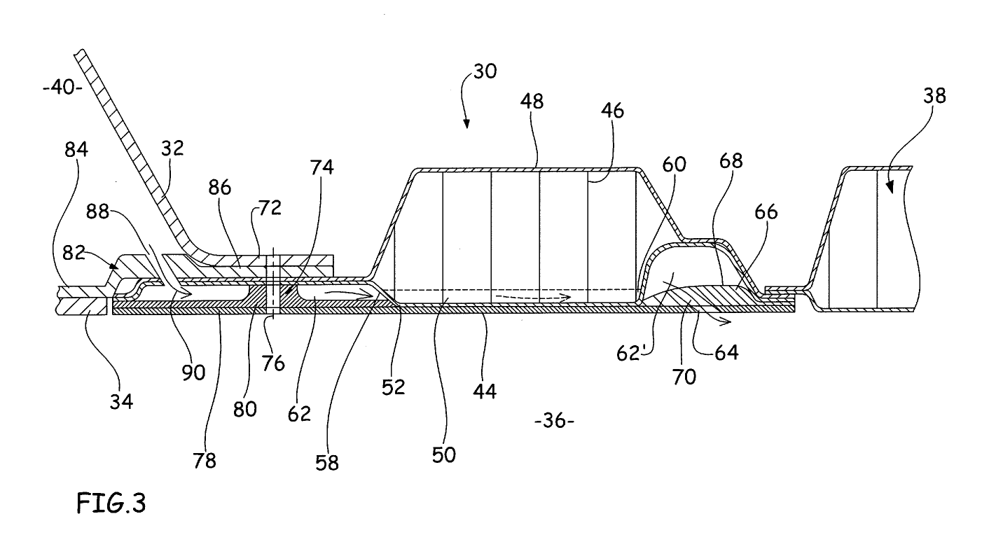

FIG. 3 is a cross-section view of a portion of an air intake according to the invention,

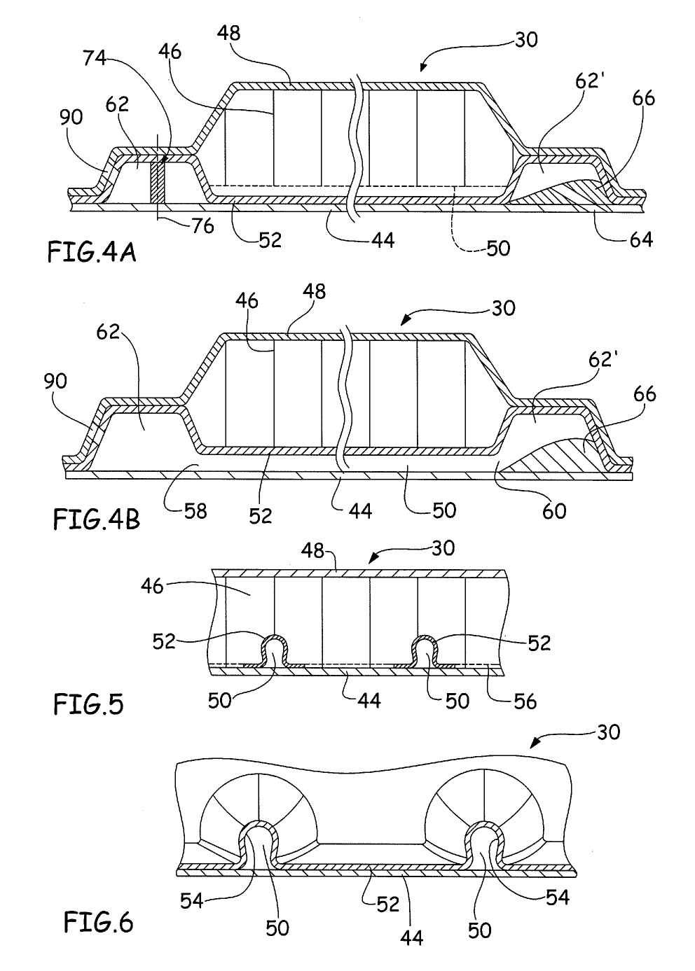

FIG. 4A is a longitudinal section along a first cross-section plane of a panel for acoustic treatment according to the invention,

FIG. 4B is a longitudinal section along a second plane of a panel for acoustic treatment according to the invention,

FIG. 5 is a cross-section along a first plane of a panel for acoustic treatment according to the invention,

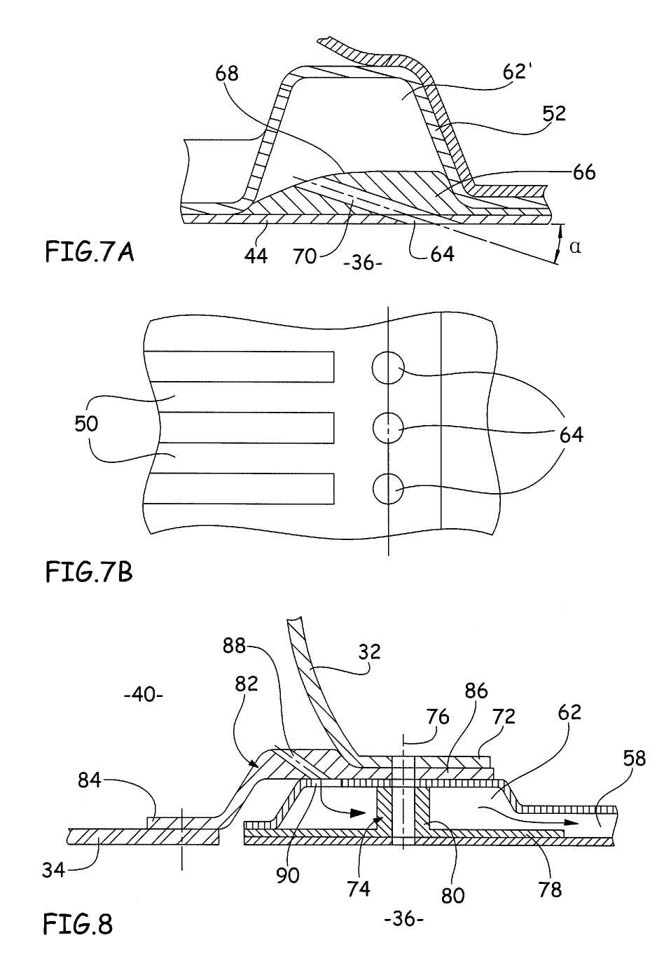

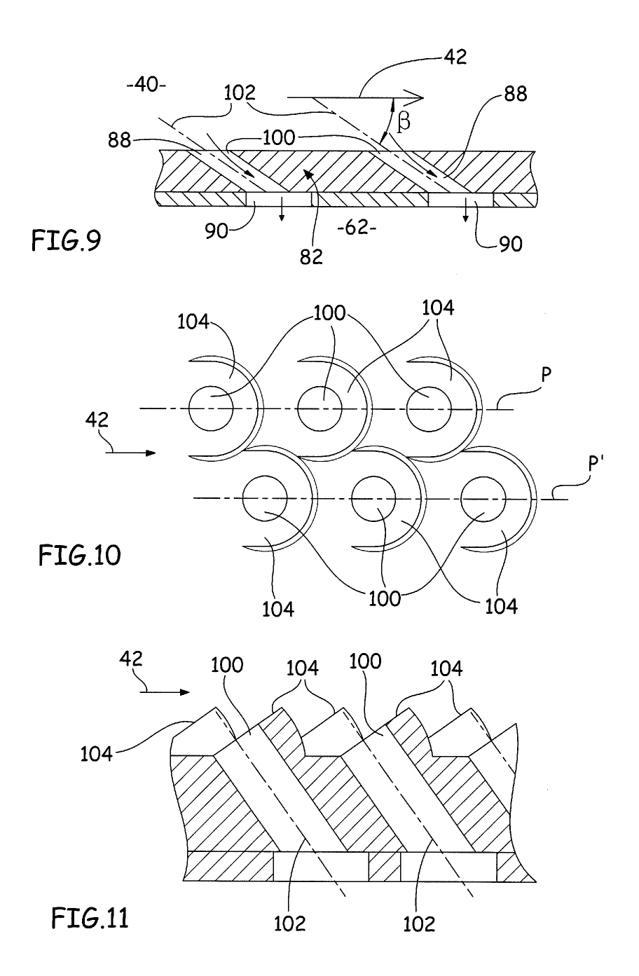

FIG. 6 is a cross-section along a second plane of a panel for acoustic treatment according to the invention,

FIG. 7A is a longitudinal section view illustrating in detail a stabilizing chamber located at the rear of the panel for acoustic treatment according to the invention,

FIG. 7B is a diagram illustrating the distribution along the circumference of hot air ducts and outlets of the panel for acoustic treatment according to the invention,

FIG. 8 is a longitudinal section view illustrating in detail one embodiment of a stabilizing chamber provided in the front of a panel for acoustic treatment,

FIG. 9 is a cross-section of an embodiment of the duct inlets of the panel for acoustic treatment according to the invention,

FIG. 10 is a view from inside the annular channel of another embodiment of the duct inlets of the panel for acoustic treatment according to the invention,

FIG. 11 is a cross-section of the embodiment shown in FIG. 10,

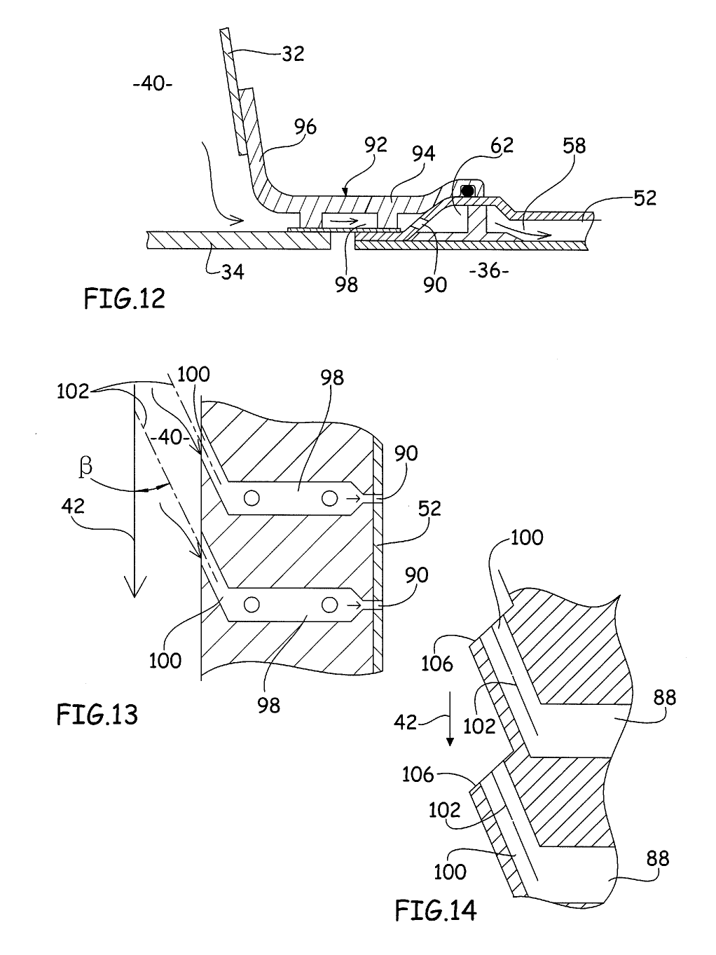

FIG. 12 is a longitudinal section view of another embodiment of the duct inlets of the panel for acoustic treatment according to the invention,

FIG. 13 is a cross-section along the circumference of the duct inlets shown in FIG. 12, and

FIG. 14 is a cross-section along the circumference of a variant of the embodiment shown in FIG. 13.

In FIG. 3, panel 30 for acoustic treatment is illustrated arranged in the rear of front frame 32 of an air intake of which part of lip 34 and the front of inner conduit 36 are illustrated. Advantageously, in the rear of panel 30, inner conduit 36 is defined by a panel for acoustic treatment 38 without frost treatment typically made of composite material.

For the remainder of the description, a longitudinal plane is a plane containing the longitudinal axis corresponding approximately to the rotating axis of the traction system. A transverse plane is a plane perpendicular to the longitudinal axis. In addition, the front of panel 30 corresponds to the portion of the panel facing the lip, while the rear of panel 30 corresponds to the portion facing the nacelle outlet.

According to the invention, in order to ensure frost treatment, hot air is injected into annular channel 40 delimited by lip 34 and front frame 32. Hot air flows into the annular channel by rotating approximately around the longitudinal axis, in a direction indicated by arrows 42 in FIGS. 9, 10, 11, 13, and 14.

For the remaining description, the panel for acoustic treatment 38, the front frame, the lip, the means for injecting hot air into the annular channel are no longer detailed because they are known to the skilled person.

In a known fashion, the panel for acoustic treatment 30 comprises, from outside inwardly, acoustic resistive layer 44, at least one honeycomb structure 46 and one reflective layer 48, and ducts 50 which extend from the front of the panel to the rear of the panel. Advantageously, ducts 50 are delimited by at least one wall interposed between acoustic resistive layer 44 and honeycomb structure 46.

According to one embodiment, ducts 50 are produced as described in document FR-2.917.067. However, the invention is not limited to the embodiment illustrated in this document. Thus, wall 52 may be formed with grooves 54 so as to define ducts 50 when pressed against acoustic resistive layer 44. Said wall 52 may comprise lightening holes 56 between ducts 50 in order to reduce material thickness crossed by acoustic waves, as shown in FIG. 5.

The shaping of wall 52, the assembling of acoustic resistive layer 44 and of wall 52, the embodiment of lightening holes 56, and the assembling the honeycomb structure and the reflective layer are not further detailed since various technical solutions may be considered.

According to one embodiment, ducts 50 extend approximately along the longitudinal direction. Alternatively, ducts 50 may have a helical shape.

Each duct 50 includes an inlet 58 connected to annular channel 40 and an outlet 60 connected to inner conduit 36.

According to the invention, the panel comprises, upstream from ducts 50, annular channel 62 which extends over at least a portion of the nacelle circumference, at least one conduit providing communication between said annular channel 62 and upstream annular channel 40, and multiple ducts 50 opening downstream into said annular channel 62. Providing an annular channel simplifies the design since the conduit(s) communicating with annular channel 40 are not necessarily aligned with ducts 50.

Preferably, inlets 58 and/or outlets 60 of ducts 50 open into annular channel(s) 62, 62′ with a flared shape.

Advantageously, annular channel 62 extends around the entire periphery of the nacelle.

Preferably, said annular channel has a section greater than that of ducts 50 so as to homogenize frost treatment over the circumference of inner conduit 36.

In order to ensure satisfactory mixing of, and to reduce disparities in, temperature and/or pressure along the circumference, annular channel 62, also called stabilizing chamber, has a cross-section greater than or equal to 1.5 times the area of one duct 50. Preferably, the annular channel has a trapezoidal cross-section in a longitudinal plane, the large base being oriented toward acoustic resistive layer 44.

Advantageously, annular channel 62 comprises a plurality of inlets connected to annular channel 40 and a plurality of outlets connected to ducts 50, and inlets and outlets are not aligned in the longitudinal direction but offset circumferentially. This arrangement helps obtain a better hot air mixture and homogenize its temperature and pressure before passing through duct 50.

Preferably, annular channel 62 may be provided upstream from ducts 50 and/or annular channel 62′ downstream from ducts 50.

According to one embodiment, each annular channel 62, 62′ is limited by a wall and acoustic resistive layer 44.

Advantageously, annular channels 62, 62′ and ducts 50 are delimited by the same wall 52. This wall is shaped by any appropriate means, including by forming.

According to one embodiment, wall 52 is in contact with acoustic resistive layer 44 upstream from annular channel 62 positioned upstream from ducts 50, and downstream from annular channel 62′ positioned downstream from ducts 50. In addition, reflective layer 48 is pressed against wall 52 at the level of annular channels 62, 62′.

At the level of annular channel 62′ provided downstream from channel 50, acoustic resistive layer 44 includes ports 64. As illustrated in FIG. 7B, to ensure better temperature homogenization, outlet ports 64 are not aligned on but offset with regards to ducts 50. Preferably, one outlet port 64 is arranged between two areas extending from adjacent ducts.

Advantageously, annular channel 62′ includes means for tilting the air flowing from outlet ports 64 and thus for limiting air flow disturbances within inner conduit 36. To this end, the panel comprises an insert 66 pressed against the inner surface of acoustic resistive layer 44, which upper surface 68 defines with wall 52 annularchannel 62′, and which comprises, for each output port 64, a conduit 70 for communication between annular channel 62′ and matching outlet 64. Advantageously, each conduit 70 forms an angle α of less than 50° with the outer surface of the resistive acoustic layer located beyond matching outlet. In order to facilitate air flow, top surface 68 of wedge 66 includes an upstream chamfered shape into which conduits 70 open.

In order to simplify the air circuit and to minimize acoustically untreated surfaces, the acoustic panel according to the invention is connected to the front frame through annular channel 62.

To this end, front frame 32 includes a rearwardly curved edge 72 pressed against the inner surface of reflective layer 48, itself pressed against wall 52 in regard to annular channel 62 positioned upstream from ducts 50. In order to reduce the risk of crushing annular channel 62, at least one wedge 74 is arranged inside annular channel 62 in regard to each means 76 providing connection between front frame 32 and the panel for acoustic treatment 30 according to the invention. In a transverse plane, wedges 74 are spaced along the circumference so as to let hot air pass from annular channel 40 to ducts 50.

According to a simplified embodiment, each wedge 74 is shaped as a tube whose axis is in line with that of connecting means 76, its height being equal to the height of annular channel 62.

Alternatively, in order to simplify mounting, the panel may include at the level of annular channel 62 positioned upstream from ducts 50, a material strip 78 which extends over at least a portion of the circumference, pressed against acoustic resistive layer 44 and including, for each connecting means 76 an embossment 80 shaped as a hollow cylinder which functions as wedge 74.

Thus, according to this embodiment, several wedges 74 are connected by material strip 78.

Preferably, the panel for acoustic treatment 30 is connected to the wall defining lip 34.

To this end, an annular part 82 provides connection between, on the one hand, the wall defining lip 34, and, on the other hand, acoustic panel 30 and advantageously front frame 32.

Depending on the case, annular part 82 may be mono-block and extend over the entire periphery of the nacelle, or be obtained from assembling several angular sectors.

According to a particular embodiment illustrated in FIG. 8, annular part 82 has, at one end, a first portion 84 formed as an annular band pressed and attached against the inner surface of the wall forming lip 34, and at the other end, a second portion 86 formed as a band placed between bent edge 72 of front frame 32 and the wall defining annular channel 62 of acoustic panel 30, second portion 86 being offset radially and outwardly relative to first portion 84 so that the outer surface of acoustic panel 30 is in line with the outer surface of the wall that defines lip 34.

This annular part 82 comprises a plurality of conduits 88 for communication between annular channel 40 and inlet 90 of annular channel 62 located upstream from acoustic panel 30.

Whatever the panel for acoustic treatment 30, the air intake comprises at least one conduit for channeling hot air from annular channel 40 to the panel for acoustic treatment 30.

In a first embodiment, shown in FIGS. 8 to 11, annular part 82 described above includes conduits 88.

According to another embodiment, illustrated in FIGS. 12 and 14, insert 92 can bridge the gap between front frame 32, the wall defining lip 34, and acoustic panel 30. Said insert 92 comprises annular body 94 with, in the front, bent plate 96 that can be pressed and secured against the rear face of front frame 32.

In this variant, the wall defining lip 34 and the front end of the acoustic panel are pressed and secured to the bottom face (oriented toward the longitudinal axis of the nacelle) by any suitable means. On its bottom face, annular body 94 comprises recessed shapes which define conduits 98.

However, the invention is not limited to these two variants for conduits delivering hot air from the annular channel to the panel for acoustic treatment.

Thus, other conduit shapes or other solutions to define a conduit may be considered.

Each feeding conduit 88 and 98 comprises a portion called opening 100 that opens into annular channel 40.

According to the invention, opening 100 is for channeling hot air in a direction referenced as 102 which forms an angle β of less than 60° with hot air flow direction 42 in the annular channel. Such arrangement ensures to capture a larger hot air flow.

According to particular variations illustrated in FIGS. 9 to 11, conduits 88 have an opening 100 whose direction 102 is contained in a plane perpendicular to the nacelle longitudinal axis.

According to a first variant illustrated in FIG. 9, openings 100 are arranged in a same transverse plane.

In another embodiment illustrated in FIGS. 10 and 11, openings 100 are arranged in at least two transverse planes P, P′. Preferably, openings 100 are distributed over two planes P, P′, and staggered.

According to a preferred embodiment, openings 100 open on surfaces 104 intersecting with hot air flow direction 42 in the annular channel.

Advantageously, surfaces 104 are perpendicular to direction 102 of the conduits.

In other embodiments illustrated in particular in FIGS. 13 and 14, conduits 88 and 98 have an opening 100 with direction 102 secant with the plane perpendicular to the nacelle longitudinal axis, and substantially tangent to the circumference of the inner conduit of the nacelle. In this case, openings 100 are arranged on the inner surface of the wall defining lip 34. According to one embodiment, in order to form the conduits, one part is pressed against the inner face of the wall defining lip 34, said part having grooves that each defines a conduit. The wall defining lip 34 being curved, a component of direction 102 of opening 100 of the conduits is directed towards the nacelle longitudinal axis.

According to one embodiment illustrated in FIG. 13, openings 100 are arranged in a plane parallel to hot air flow direction 42 in the annular channel.

In another embodiment illustrated in FIG. 14, openings 100 open on surfaces 106 secant with hot air flow direction 42 in the annular channel. Advantageously, surfaces 106 are perpendicular to direction 102 of the conduits.

1. An aircraft nacelle comprising a lip extended by an inner conduit forming an air intake, a front frame delimiting with said lip annular channel within which hot air circulates and a panel for acoustic treatment comprising, from outside inwardly, an acoustic resistive layer, at least one honeycomb structure and one reflective layer as well as ducts for channeling hot air, at least one conduit with opening which opens into annular channel being provided for carrying hot air up to the panel for acoustic treatment, wherein opening is used for channeling hot air in direction which forms an angle β of less than 60° with hot air flow direction into annular channel.

2. Aircraft nacelle according to claim 1, wherein direction is contained in a plane perpendicular to the longitudinal axis of the nacelle.

3. Aircraft nacelle according to claim 2, wherein openings are offset forwardly with respect to front frame.

4. Aircraft nacelle according to claim 1, wherein conduits are pressed against the inner surface of the wall defining lip.

5. Aircraft nacelle according to claim 4, wherein it comprises a part pressed against the inner face of the wall defining lip, said part having grooves with each groove defining a conduit.

6. Aircraft nacelle according to claim 1, wherein openings are arranged in several planes.

7. Aircraft nacelle according to claim 6, wherein openings are staggered.

8. Aircraft nacelle according to claim 1, wherein openings open on surfaces intersecting with direction of the hot air flow in the annular channel.

9. Aircraft nacelle according to claim 8, wherein surfaces are perpendicular to direction.

10. Aircraft nacelle according to claim 1, wherein it comprises part which ensures the connection between front frame, the panel for sound processing, and the wall defining lip with at least one conduit provided for carrying hot air from annular channel to the panel for acoustic treatment.
